(19) United States
(12) Patent Application Publication
(10) Pub. No.: US 2005/0102499 A1
(43) Pub. Date: May 12, 2005

(54) Apparatus for proving original document of electronic mail

(76) Inventors: Masayuki Kosuga, Tokyo (JP); Hiroyasu Nunokami, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/948,269

(22) Filed: Sep. 24, 2004

(30) Foreign Application Priority Data
Sep. 25, 2003 (JP) 2003-332655

(51) Int. Cl. H04L 9/00

(52) U.S. Cl. 713/152

(57) ABSTRACT

An authenticity assurance apparatus for e-mail documents which preserves a transmitted e-mail includes a unit to add a digital signature to an e-mail document and a file attached to it at time of transmitting the mail from a sender and from the apparatus; a unit to check for a mail tampering by using the digital signature at time of receiving the mail by the apparatus and by a recipient; a unit to inform the sender and the recipient of the tampering when detected; a unit to preserve the mail and the associated data on an unoverwritable database; a unit to meet a requirement of integrity by creating and adding a time stamp; a unit to encrypt and preserve the e-mail document and the attached file; and a unit to meet a requirement of confidentiality of the e-mail document by limiting an access to the database.

### BACKGROUND OF THE INVENTION

The present invention relates to an electronic mail management apparatus for preserving transmitted electronic mail documents and files attached to them, and more specifically to an authenticity assurance apparatus for e-mail document to authenticate electronic mail documents and files attached to them.

Electronic mail or e-mail has become an essential part of our everyday life and a range of its use is growing steadily. The Ministry of Justice has adopted a policy of permitting a filing of complaints of civil suits and exchanges of their preparatory documents in the form of e-mail and a policy of requiring internet service providers to keep mails in safe storage as evidence for a predetermined period.

So, devices to store e-mail documents are needed and a variety of devices are being proposed, which include, for example, one that stores mails a sender transmitted as CC (carbon copy), as disclosed in JP-A-2002-344525, and one which receives and stores mails from a sender before forwarding them to a recipient, as described in JP-A-10-93620.

### SUMMARY OF THE INVENTION

Since a content recorded in an electronic medium can be modified easily, it is required in storing an e-mail to assure an “authenticity” of the e-mail document. The authenticity requires the following three conditions to be met: “integrity”, which means that the document in question is what it is claimed to be, that it is free from manipulation and that, if the document is tampered with, it can be detected; “confidentiality”, which means that a content of the document cannot be accessed by other than authorized persons; and “availability”, which means that the content of the document can be seen and read.

An apparatus disclosed in JP-A-2002-344525 has only a function of storing copies of mails, so if a mail is manipulated while on transmission routes, a recipient may receive it without noticing the tampering. Also a sender has no means at all of knowing what the recipient actually received. That is, the conventional device has a serious defect in terms of integrity. An apparatus described in JP-A-10-93620 does not employ any measure for mail encryption and access control on the storage unit and thus has a problem with a particularly important aspect of privacy.

An object of this invention is to solve the above problems and provide an apparatus for preserving e-mail documents which has a function to guarantee an integrity, a confidentiality and an availability thereby assuring an “authenticity” of e-mail documents preserved.

To solve the above problem, the authenticity assurance apparatus for e-mail documents according to one aspect of this invention comprises means for detecting a tampering with an e-mail document and a file attached to it means for informing a sender and a recipient of a tampering when detected means for encrypting the e-mail document and the attached file and preserving them on a database means for creating a time stamp and attach it to the e-mail and means for restricting an access to the database in which the e-mail is preserved.

In the authenticity assurance apparatus for e-mail documents, the tampering detection means adds a digital signature to the e-mail document and the attached file at time of transmitting the mail from the sender and from the authenticity assurance apparatus. By using the digital signature, the tempering detection means performs the tampering detection when the mail is received by the authenticity assurance apparatus and by the recipient. When a tampering is detected, the tempering notifying means analyzes the addresses of the mail sender and recipient and informs the detection of mail tampering to these addresses. The means for encrypting the e-mail document and the attached file and preserving them on the database stores the e-mail document and the attached file on the unoverwritable database.

Further, the authenticity assurance apparatus precisely records a time of transmission and reception of an e-mail, which is of great importance, and creates a time stamp that enables a detection of tampering and adds it to the mail. The above steps satisfy a requirement of integrity. Further, the preserving means of the authenticity assurance apparatus encrypts and preserves the e-mail document and attached file and also limits an access to the database, thereby satisfying a requirement of confidentiality of the e-mail document and the file attached to it. Furthermore, a requirement of availability can be met by allowing the user to access the database and make a retransmission request for the e-mail document and the attached file, or allowing them to be displayed on a screen from the Web. As described above, the authenticity assurance apparatus for e-mail documents of this invention can assure an authenticity of e-mail documents and files attached to them.

These and other objects, features and advantages of this invention will become apparent from the following description of embodiments thereof in connection with the accompanying drawings.

### BRIEF DESCRIPTION OF THE DRAWING

FIG. 1 is a block diagram showing a configuration of an embodiment of this invention.

FIG. 2 illustrates a user registration procedure.

FIG. 3 illustrates a procedure for sending a mail from a user.

FIG. 4 illustrates a flow of operation of the authenticity assurance apparatus for e-mail documents when an e-mail is received.

FIG. 5 illustrates a flow of conversion of files when an e-mail is received.

FIG. 6 illustrates a method of creating a time stamp signature.

FIG. 7 illustrates a method of verifying a time stamp signature on a receiver side device.

FIG. 8 illustrates a method of verifying a time stamp signature on the authenticity assurance apparatus for e-mail documents.

FIG. 9 illustrates a perfect method of verifying a time stamp signature.

FIG. 10 illustrates a user registration procedure in a second embodiment of this invention.

### DETAILED DESCRIPTION OF THE EMBODIMENTS

Embodiments of this invention will be described in detail by referring to the accompanying drawings.

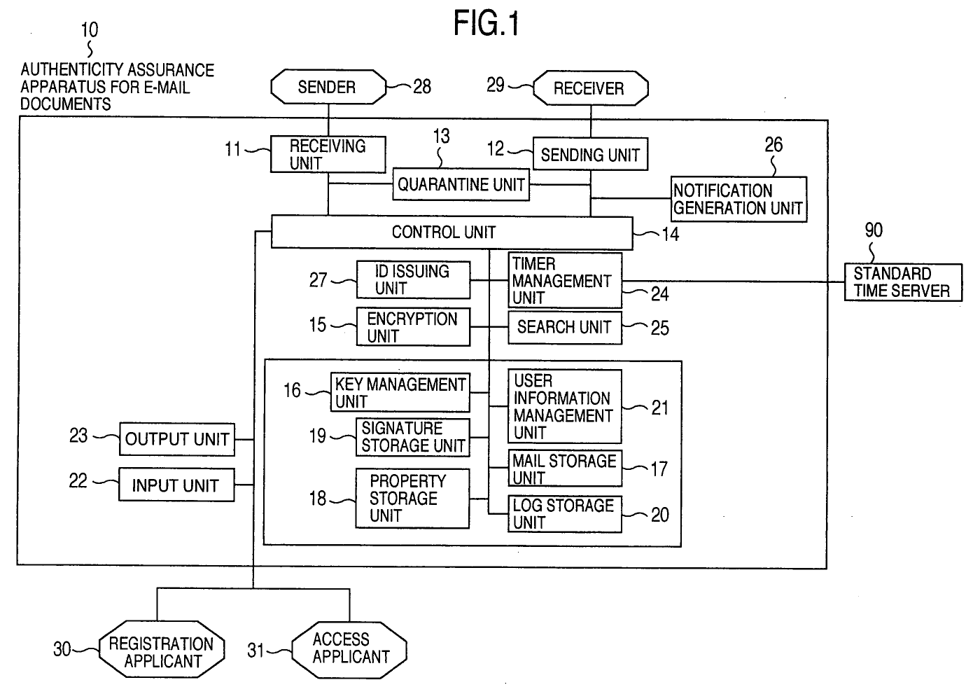

FIG. 1 is a block diagram showing a configuration of an authenticity assurance apparatus for e-mail documents 10 of a first embodiment of this invention. The authenticity assurance apparatus for e-mail documents 10 of the first embodiment, as shown in the figure, includes: a receiving unit 11 to receive mails from a sender 28, a sending unit 12 to send a mail to a receiver 29 and the sender 28, a quarantine unit 13 to check a received mail and a mail to be transmitted for virus, a control unit 14 to control entire processing, an encryption unit 15 to encrypt/decrypt a variety of data and to create/verify a signature, a key management unit 16 to manage a key, a mail storage unit 17 to store a mail body and an attached file, a property storage unit 18 to store mail property information and reception/storage time information, a signature storage unit 19 to store a signature created when a sender transmits a mail and a time stamp signature created by the authenticity assurance apparatus for e-mail documents 10, a log storage unit 20 to store logs, a user information management unit 21 to manage user IDs, an input unit 22 to accept inputs of registration applicant 30 and access applicant 31 from a screen on the Web, an output unit 23 to output to the screen, a timer management unit 24 linked with a standard time server 90 to adjust a system time properly at all times, a search unit 25 to accept a request from a user and retrieve a mail, a notification generation unit 26 to generate a notification mail, and an ID issuing unit 27 to issue an ID to a user and a mail.

The key management unit 16, the mail storage unit 17, the property storage unit 18, the signature storage unit 19, the log storage unit 20 and the user information management unit 21 all store mail bodies, attached files, properties, user information, signatures and keys on an unoverwritable database to enhance the integrity. At the same time, the confidentiality is improved by placing the database on a server which is securely protected by an access control by password, an arrangement of console terminals in a room whose entrance is severely restricted and a strict recording of various logs, including access logs and operation logs. The mail bodies, attached files, properties, user information and keys are encrypted before being stored in order to enhance the confidentiality, and the mail bodies, attached files, properties, user information and logs are attached with a manipulation detection signature before being stored in order to enhance the integrity.

The use of this system begins with a member registration of applicants (a group of two or more users).

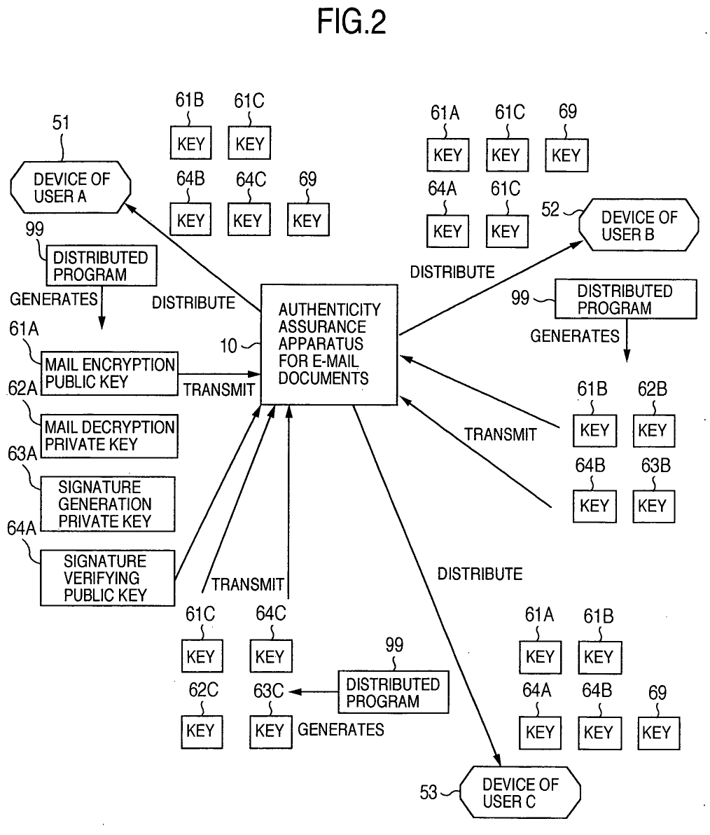

FIG. 2 shows a procedure for registering applicants. While FIG. 2 illustrates a case of three applicants, the same registration procedure described below applies if the number of applicants is greater than three. The applicants 51-53 perform a user registration with the system on the Web. At this time the applicants 51-53 register information such as name, mail address and password for certification from the input unit 22. The ID issuing unit 27 issues an ID for each user. The registered information is encrypted by an encryption/decryption key for storage 65 stored in the key management unit 16 and then stored in the user information management unit 21.

After registration, the applicants 51-53 download from the output unit 23 a distribution program 99 that performs encryption/decryption of a mail, creation/verification of a signature, generation of a key, conversion of a mail property, and automatic transmission of a reception confirmation mail and a warning mail. The distribution program 99 includes the same hash algorithm 98 that is used by the authenticity assurance apparatus for e-mail documents 10 in creating a time stamp signature.

Using the distribution program 99, the applicants 51-53 create a mail encryption public key 61, a mail decryption private key 62 to be paired with the public key 61, a signature creation private key 63 and a signature verification public key 64 to be paired with the private key 63. Then the user sends the mail encryption public key 61 and the signature verifying public key 64 for group members to the authenticity assurance apparatus for e-mail documents 10. The authenticity assurance apparatus for e-mail documents 10 distributes the mail encryption public key 61 and the signature verifying public key 64 to all members of the group. At this time, a time stamp signature verifying public key 69 is also distributed. Then, information about who created the individual keys is encrypted by the encryption/decryption key for storage 65 before being stored in the user information management unit 21, and the mail encryption public key 61 and the signature verifying public key 64 for the group members are encrypted by an encryption/decryption key for key storage 66 before being stored in the key management unit 16.

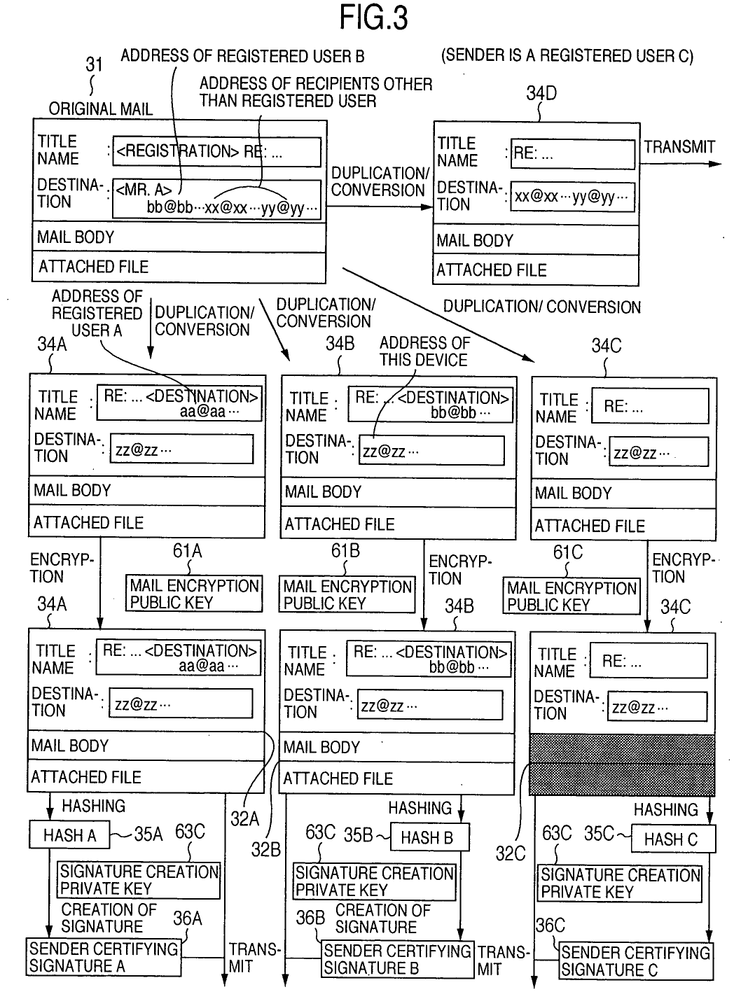

FIG. 3 shows a procedure for sending a mail from a user (a sender is represented as C, and recipients as A and B). In using the system, the sender adds a <registration> tag at the foremost part of a title name. The addition of this tag causes a conversion of addresses as shown below. This is intended to reduce a burden on the part of the user to only the addition of a tag. A destination may be specified either with an ordinary mail address of a recipient or with a registered user name of the recipient enclosed by < >. Immediately after the sender has issued a transmit command, the distribution program 99 checks if the <registration> tag is included in the title name of the original mail 31. If not, the original mail 31 is transmitted as it is, without being subjected to any operations.

If the <registration> tag is found included, the properties are converted by the distribution program 99 into converted properties 34A-D as described below. First the <registration> tag is eliminated from the title name. Next, a check is made as to whether the destinations are all registered users. If the destinations are only the registered users, the mail is reproduced in number equal to the number of registered users in the destination field plus 1; and if the destinations include other than the registered users, the mail is reproduced in number equal to the number of registered users in the destination field plus 2. In the latter case, the one excess mail has the address field removed of all the registered users, i.e., the destinations are set to all recipients other than the registered users, and at this point in time the mail is transmitted.

Each of the reproduced mails has its destinations set at the end of the title name, following the <destination> tag and commented out for each registered user (if the destination is specified with a user name of a recipient, it is converted into an address). One excess mail has no information inserted following the <destination> tag. Then, the destinations are converted into only the address of the authenticity assurance apparatus for e-mail documents 10. Now, the converted properties 34A-C are obtained. The reason for converting the title name as described above is that since the body portion of the mail is encrypted using the mail encryption public key 61, for which the authenticity assurance apparatus for e-mail documents 10 has no corresponding mail decryption private key 62, the information on who the mail is to be sent to needs to be saved in a title name portion that is not subject to encryption.

Next, the body of the original mail 31 and the attached file are encrypted. For the encryption, the mail encryption public key 61 commented out immediately following the <destination> tag in each of the conversion properties 34A-B is used for each mail. That is, if there are two or more registered users in the destination field, as many encrypted mails as the destinations are generated by using different encryption keys assigned to different destinations. One excess mail is encrypted by using a mail encryption public key 61C for which the sender himself or herself has the corresponding mail decryption private key 62. This mail is used by the sender himself for later reference. In this way the encrypted mail bodies 32A-C are created. The reason for separating mails and using different mail encryption public keys 61 in encrypting the mails is to ensure that an administrator of the authenticity assurance apparatus for e-mail documents 10 and an illegal intruder cannot view the content of mails received. To view the mail content requires the mail decryption private key 62 of the destination user, so it cannot be read by other than the destination user.

As a last step, the encrypted mail body 32A-C is hashed into a hash 35A-C by the hash algorithm 98. The encryption algorithm uses the hash 35A-C and a signature generation private key 63C for C as arguments to create a sender certifying signature 36A-C. When there are two or more destinations, different sender certifying signatures 36A-C are created for the different destinations. The sender certifying signature 36 is a signature to assure both the authenticity assurance apparatus for e-mail documents 10 and a recipient that the mail has truly been transmitted from this sender. The sender certifying signature 36A-C is attached to the encrypted mail body 32A-C so that the encrypted mail body 32A-C, the converted property 34A-C and the sender certifying signature 36A-C are transferred to the authenticity assurance apparatus for e-mail documents 10.

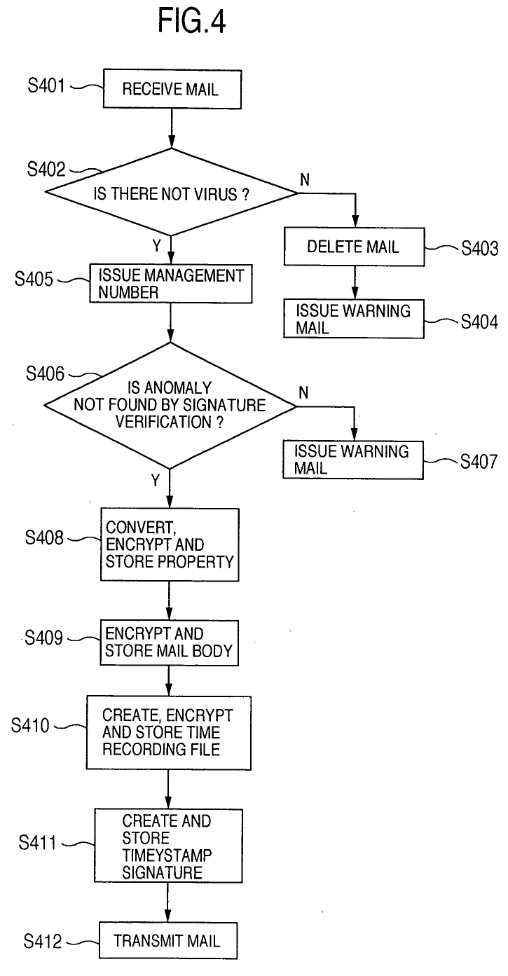

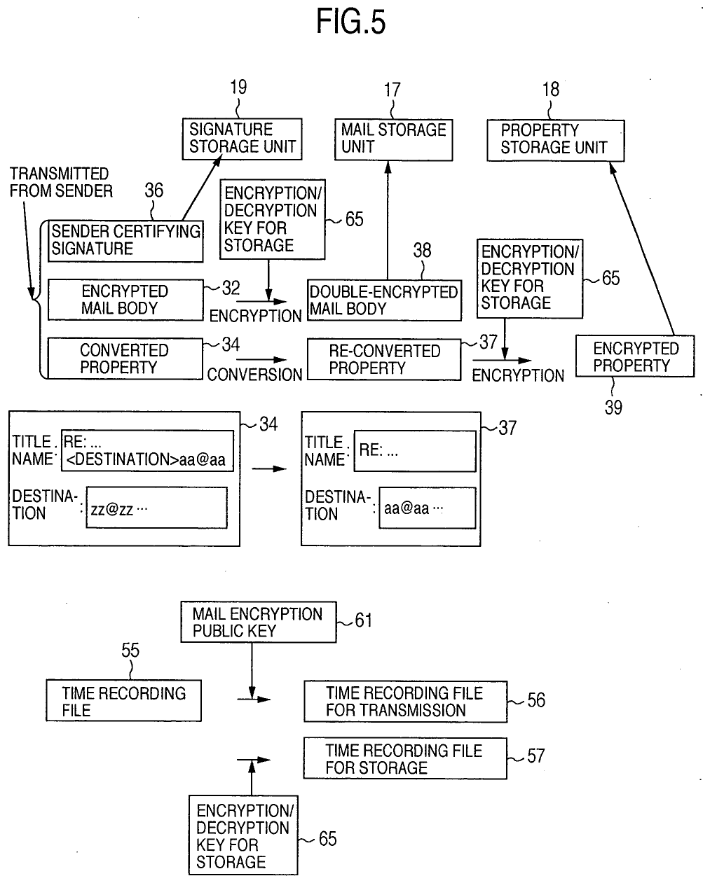

FIG. 4 shows a flow of operations performed by the authenticity assurance apparatus for e-mail documents 10 when a mail arrives. FIG. 5 shows a flow of conversion of files when a mail arrives. First, the receiving unit 11 receives a mail transmitted from a sender (S401). When the mail is received, a time of mail reception is recorded by the timer management unit 24, from which it is transferred to the control unit 14. The received mail is first transferred to the quarantine unit 13 for virus check (S402). If any virus is detected, the mail is immediately discarded (S403) and a warning mail is issued to the sender (S404). The warning mail is encrypted by using the mail encryption public key 61 for the destination and its mail body is hashed by the hash algorithm 98. A warning mail signature, which is encrypted by using a time stamp signature generation private key 68, is attached to the warning mail before it is transmitted. The warning mail informs the sender that the mail the sender transmitted contained a virus and was therefore deleted and that the sender must be alert for viruses. The method of generating and sending a warning mail also applies to warning mails that are created and issued in the subsequent steps. If no virus is detected, the received mail is transferred to the control unit 14, which then retrieves a mail ID from the ID issuing unit 27 and attaches it to the received mail (S405).

The control unit 14 retrieves sender information from the converted property 34 and hands it over to the user information management unit 21. The user information management unit 21 returns a user ID of the sender 51 to the control unit 14, which in turn gives it to the key management unit 16. The key management unit 16 returns a signature verifying public key 64 to the control unit 14. Then, the control unit 14 transfers to the encryption unit 15 the encrypted mail body 32, the converted property 34, the sender certifying signature 36 and the signature verifying public key 64 for the sender. The encryption unit 15 hashes a combination of the encrypted mail body 32 and the converted property 34 linked together by using the same hash algorithm 98 as the one used by the distribution program 99 (if normal, a hash 35 is obtained). This is matched against the decrypted sender certifying signature 36 (if normal, a hash 35 is obtained). The result of the signature verification is returned from the encryption unit 15 to the control unit 14 (S406).

If the signature verification finds any anomaly, the control unit 14 demands the notification generation unit 26 to generate a warning mail, which is transmitted from the sending unit 12 to the sender. The warning mail notifies the sender that the mail the sender transmitted may have been tapered with before it arrived at this system and also alerts the sender (S407).

If no anomaly is detected by the signature verification, the converted property 34 is transformed into a re-converted property 37. The conversion performed here involves transforming the destination from the authenticity assurance apparatus for e-mail documents 10 to the destination that was saved following the <destination> tag put at the end of the title name and deleting the <destination> tag and the following information from the title name field of the mail. This conversion is done to restore the title name to the one the sender originally created. Further, the re-converted property 37 is encrypted by the encryption/decryption key for storage 65 to generate an encrypted property 39, which is then stored in the property storage unit 18 (S408).

Next, the encryption unit 15 encrypts the encrypted mail body 32 by using the encryption/decryption key for storage 65 to create a double-encrypted mail body 38. That is, the mail body and the attached file are doubly encrypted by the sender 51 and the authenticity assurance apparatus for e-mail documents 10. Since the decryption keys, i.e., the mail decryption private key 62 and the encryption/decryption key for storage 65, are stored in different places, the confidentiality can be enhanced much more. The double-encrypted mail body 38 thus generated is stored in the mail storage unit 17 and a storage time is recorded by the timer management unit 24 and transferred to the control unit 14 (S409).

After the double-encrypted mail body 38 has been stored, an ID/time recording file 55 is created that describes a mail ID, a time at which the mail arrived at the authenticity assurance apparatus for e-mail documents 10 and a time at which the double-encrypted mail body 38 was stored. In this process, the system time of the authenticity assurance apparatus for e-mail documents 10 is used as a reference and, since the timer management unit 24 is liked with a standard time server to properly adjust the system time at all times, the system time is highly reliable.

After it is created, the ID/time recording file 55 is encrypted by the mail encryption public key 61 and the encryption/decryption key for storage 65 for the destination user to generate a time recording file for transmission 56 and a time recording file for storage 57, respectively. The time recording file for transmission 56 is later used in generating a time stamp signature 60 and then transmitted to the recipient to inform the recipient of the time at which the mail was received and recorded in the authenticity assurance apparatus for e-mail documents 10 and the mail ID. The time recording file for storage 57 is stored in the property storage unit 18 and holds information that matches the mail ID with the arrival and recorded time at which the mail arrived at and was recorded in the authenticity assurance apparatus for e-mail documents 10 (S410).

Next, the control unit 14 retrieves the time stamp signature generation private key 68 from the key management unit 16 and the previously generated time stamp signature 81 from the signature storage unit 19 and transfers them to the encryption unit 15. The “previously generated time stamp signature 81” does not necessarily have the same sender as the mail that is going to be given a time stamp signature. A time stamp signature ID given by the ID issuing unit 27 simply represents the latest one at this point in time. Then, the encrypted mail body 32, the re-converted property 37, the previously generated time stamp signature 81, and the time recording file for transmission 56 are used to create the time stamp signature 60. At time of generation, the time stamp signature 60 is given a time stamp signature ID. The method of generating the time stamp signature 60 will be detailed later. The sender certifying signature 36 and the time stamp signature 60 are stored in the signature storage unit 19 (S411).

The time stamp signature 60, as its name implies, plays a role of a time stamp and is attached to a mail as a certificate that the mail was actually stored in the authenticity assurance apparatus for e-mail documents 10. As a last step, the encrypted mail body 32, the re-converted property 37, the sender certifying signature 36, the time stamp signature 60 and the time recording file for transmission 56 are transmitted from the sending unit 12 to the recipient (S412).

When the mail arrives at the recipient, the distribution program 99 verifies the sender certifying signature 36 using the signature verifying public key 64 and then performs a signature verification on the time stamp signature 60 according to a method described later. If the verification result is abnormal, the distribution program 99 outputs a warning message to an output device (e.g., monitor) of a computer of the recipient to notify the recipient of an abnormality and also issues a warning mail to the authenticity assurance apparatus for e-mail documents 10. When the authenticity assurance apparatus for e-mail documents 10 receives a warning mail, it sends the warning mail to the sender and other recipients. If the validation result is normal, the distribution program 99 transmits a reception acknowledge mail to the authenticity assurance apparatus for e-mail documents 10. The reception acknowledge mail is attached with a recipient certifying signature, which is generated by converting the hash 32H of the encrypted mail body by the signature creation private key 63 owned by the recipient, the hash 32H of the encrypted mail body being obtained by decrypting the time stamp signature 60 using the time stamp signature verifying public key 69. Upon receiving the reception acknowledge mail, the authenticity assurance apparatus for e-mail documents 10 verifies the recipient certifying signature by using the stored double-encrypted mail body 38 and the signature verifying public key 64 for the recipient. Since the generation of the recipient certifying signature requires the time stamp signature 60, the time stamp signature verifying public key 69 and the signature verifying public key 64 for the recipient, the recipient certifying signature is very difficult to forge, making it detectable if a mail should be stolen by an intruder before it reaches an intended recipient and a forged acknowledge mail transmitted instead.

If the result of verification is abnormal, an alert mail is issued to the computers of the sender and all recipients. The authenticity assurance apparatus for e-mail documents 10 receives the reception acknowledge mails from all recipients and, if they are all found to be normal, sends a confirmation mail describing a transmission/reception success message and a mail ID. With the above steps taken, the process of a mail transmission and reception is completed.

As for the mails stored in this system, the sender and the recipient can issue a retransmission request at any time. This is done as follows. When a user logs in to a Web page using his or her registered user ID and password, the input unit 22 issues a search request to the search unit 25. In the search unit 25 a correspondence table that matches mail IDs with the corresponding user IDs of the mail senders/recipients is prepared in advance. Using the table, the search unit 25 identifies mails that the user transmitted or received, decrypts the encrypted properties 39 of the mails by using the encryption/decryption key for storage 65, and displays a list of mail IDs, title names and senders/recipients on the screen. Then, using the property information as a search key, the user can search for a mail for which he or she wishes to issue the re-transmission request. Based on the search result, the user selects a mail he or she wants retransmitted and the sending unit 12 retransmits the selected mail.

It is also possible to directly view the content of a mail and an attached document on the Web without a mail retransmission by temporarily sending the mail decryption private key 62 to the authenticity assurance apparatus. If the mail decryption private key 62 is sent over to the authenticity assurance apparatus, not only the search using the property information as a search key but also a full-text search and a conceptual search for a mail document become possible as a search option. It is noted that, to ensure confidentiality, the decrypted mail and the mail decryption private key 62 are erased when the session is over. The retransmission request for and the on-the-Web access to the mail can basically be made only by the sender and the recipient.

However, the sender can set an access right to allow the group members an access to the mail. The modification of the access right is done basically on the Web. An access to the mail requires the mail decryption private key 62. So, the sender can choose between two options: one is to send, when setting the access right, the mail decryption private key 62 to the authenticity assurance apparatus for e-mail documents 10 so that the key 62 is always present in the authenticity assurance apparatus; and the other is to issue a request for the sender to transfer the mail decryption private key 62 to the system each time an access request is made, so that if the sender accepts the request, he or she sends the mail decryption private key 62 to the system (the latter assures a higher confidentiality).

The authenticity assurance apparatus for e-mail documents 10 periodically performs a tamper detection on automatically stored data by using a signature. When a tampering is detected, the authenticity assurance apparatus 10 issues an alert message to a system administrator and also an alert mail to the sender and recipient of the manipulated mail/property.

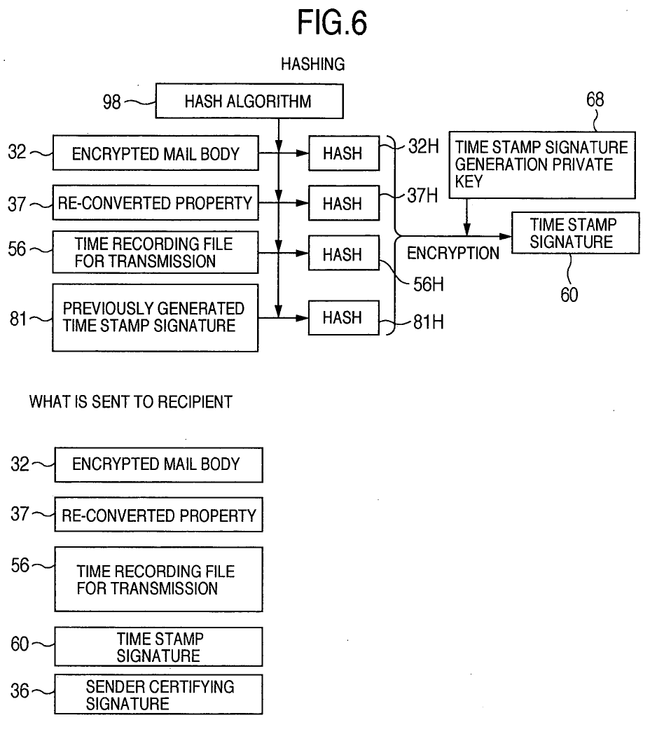

FIG. 6 shows a detailed method of generating a time stamp signature 60. The following description basically applies JP-A-2002-335241. First, the encrypted mail body 32, the re-converted property 37, the time recording file for transmission 56 and the previously generated time stamp signature 81 are hashed by the hash algorithm 98 to produce hashes 32H, 37H, 56H, 81H. Then, these four hashes are coupled together by a predetermined method and encrypted using the time stamp signature generation private key 68 to create the time stamp signature 60. Immediately after its creation, the time stamp signature 60 is given a time stamp signature ID by the ID issuing unit 27.

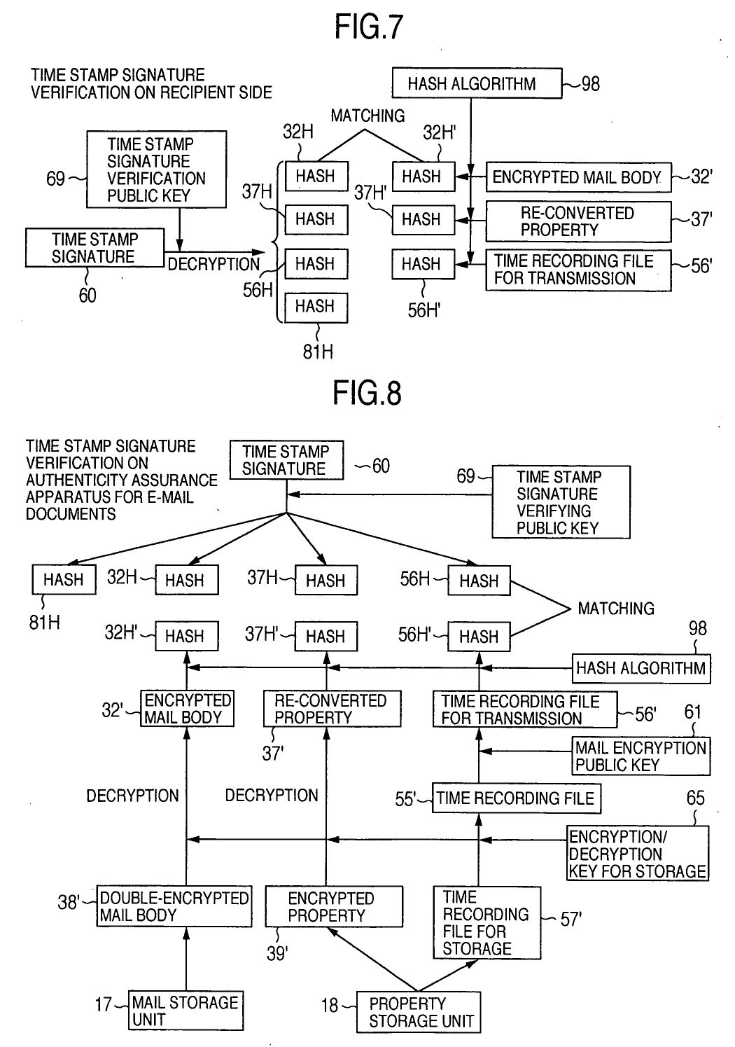

FIGS. 7 to 9 illustrate a method of verifying the time stamp signature 60. There are three verifying methods. FIG. 7 illustrates a method of verifying the time stamp signature 60 on the recipient side. The role of this verification is to check whether or not the encrypted mail body 32′, the re-converted property 37′ and the time recording file for transmission 56′, all transmitted to the recipient, have been tampered with. First, the time stamp signature 60 is decrypted by the time stamp signature verifying public key 69 to obtain hashes 32H, 37H, 56H, 81H. Next, the encrypted mail body 32′, the re-converted property 37′ and the time recording file for transmission 56′ are hashed by the hash algorithm 98 to obtain hashes 32H′, 37H′, 56H′. Then, matching is made between 32H′ and 32H, between 37H′ and 37H, and between 56H′ and 56H. If no difference is detected, it is concluded that the possibility that the encrypted mail body 32′, the re-converted property 37′ and the time recording file for transmission 56′ have been tampered with is very low.

Next, FIG. 8 illustrates a method of verifying the time stamp signature 60 on the authenticity assurance apparatus side. This verification method checks whether or not the double-encrypted mail body 38′ stored in the mail storage unit 17 of the authenticity assurance apparatus for e-mail documents 10 and the encrypted property 39′ and time recording file for storage 57′ both stored in the property storage unit 18 have been tampered with.

First, the time stamp signature 60 is decrypted by the time stamp signature verifying public key 69 to obtain hashes 32H, 37H, 56H, 81H. Next, the double-encrypted mail body 38′, the encrypted property 39′ and the time recording file for storage 57′ are decrypted by using the encryption/decryption key for storage 65 to obtain an encrypted mail body 32′, re-converted property 37′ and time recording file 55′. Next, the time recording file 55′ is encrypted using the mail encryption public key 61 of the mail destination user to obtain a time recording file for transmission 56′.

Then, the encrypted mail body 32′, the re-converted property 37′ and the time recording file for transmission 56′ are hashed by the hash algorithm 98 to obtain hashes 32H′, 37H′, 56H′. In a final step, matching is made between 32H′ and 32H, between 37H′ and 37H and between 56H′ and 56H. If no difference is found, it is concluded that the possibility that the double-encrypted mail body 38′, the encrypted property 39′ and the time recording file for storage 57′ have been tampered with is very low.

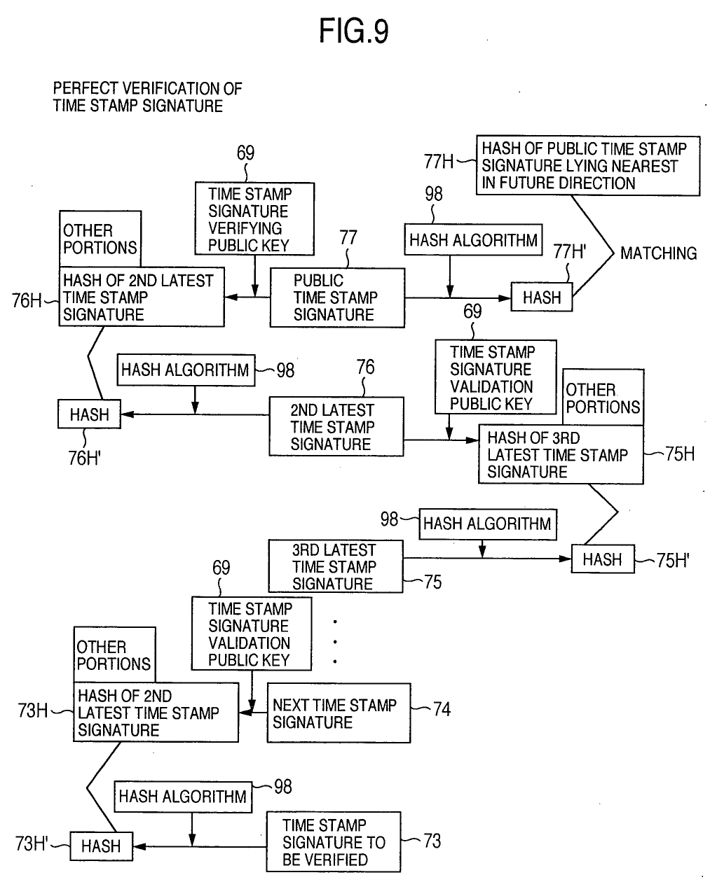

FIG. 9 illustrates a method of precisely verifying the time stamp signature 60. The role of this verification method is to check whether or not the time stamp signature 60 has been manipulated, i.e., it certifies that the time stamp signature 60 properly functions as a time stamp.

Before this verification can be made, a precondition needs to be established that a hash 77H of a time stamp signature, which was created later than a time stamp signature that is going to be verified, be made public through a mass-communication organization. (A time stamp signature whose hash has been made public is referred to as a public time stamp signature 77.) Since it is practically impossible to alter the hash 77H of the public time stamp signature, i.e., to recover all newspapers and others that have published the hash 77H of the time stamp signature and alter their contents, the hash 77H of the public time stamp signature can be said to have an integrity.

The verification begins by searching for a public signature which lies in a future direction from and is closest to the time stamp signature 73 to be verified (here, a public time stamp signature 77). Of the public time stamp signatures 77, one having a time stamp signature ID which is larger than and nearest the time stamp signature 60 to be verified is what needs to be retrieved. After the public time stamp signature 77 has been found, it is hashed by the hash algorithm 98 to generate a hash 77H′. The generated hash 77H′ is matched against the public hash 7H of the time stamp signature. If they agree, the integrity of the public time stamp signature 77 has been proved.

Next, a time stamp signature 76, which is one time stamp older than the public time stamp signature 77, i.e., whose time stamp ID is smaller than that of the public time stamp signature 77 by one, is hashed by the hash algorithm 98 to create a hash 76H′. The hash 76H′ is matched against a hash 76H, or a “hash of the last time stamp signature”, which is obtained by decrypting the public time stamp signature 77 using the time stamp signature verifying public key 69. If they agree, the integrity of the time stamp signature 76 is proved. This operation is repeated one time stamp at a time until the time stamp signature 73 to be verified is reached. If the matching operation is successfully completed to the end, the integrity of the time stamp signature 73 has been proved. The above is an explanation of the precision verification method.

Further, if a valid term of the time stamp signature generation private key 68 used in creating a signature should expire due to the precision verification on a large scale can maintain the valid term of the time stamp signature 60 semi-permanently without re-creating the signature. The precision verification normally begins with a public signature which lies in a future direction from and is closest to the time stamp signature to be verified. This alone can make practically impossible the manipulation of the hash of the public time stamp signature and thus can be said to be sufficient. It is however noted that if the valid term of the time stamp signature generation private key, which was used in creating a public signature that lies in a future direction from and is closest to the time stamp signature to be validated, should expire, there is some uncertainty on reliability.

Therefore, the precision verification is started from a public signature that was made public the latest. In this case, the integrity of the time stamp signature in question will be actually verified by the latest public signature. Naturally, the valid term of a certificate of the time stamp signature generation private key used in creating the latest public signature lies in the future direction far beyond the time stamp signature generation private key that has been used to create the time stamp signature to be verified. That is, by starting the precision verification from the latest public signature, the integrity of the time stamp signature of interest is assured by the certificate of the time stamp signature generation private key whose term of validity lies, though seemingly, in the future.

As a result, once a time stamp signature is assigned to a mail, if the valid term of the certificate of the private key that was used to create the time stamp signature should expire, there is no need to change the private key to a new one and re-create a new signature as long as the hash of the time stamp is made public at an appropriate time.

As described above, the use of the time stamp signature can maintain the integrity of data stored in the authenticity assurance apparatus for e-mail documents 10 practically semi-permanently.

According to the first embodiment described above, the requirement of integrity is satisfied by the procedure which involves giving a digital signature to an e-mail document and its attached file when a sender dispatches a mail and when the authenticity assurance apparatus for e-mail documents transmits the mail; detecting any tampering by using the digital signature when the authenticity assurance apparatus receives the mail and when a recipient receives the mail; when a manipulation is detected, notifying the sender and the recipient of the manipulation; storing an object to be stored in an unoverwritable database; and then creating and attaching a time stamp to the object. The requirement of confidentiality of the e-mail and its attached file is met by the procedure which involves encrypting the e-mail document and its attached file before storing them and limiting an access to the database in which they are stored. The requirement of availability is met by retransmitting the mail upon request. The authenticity of the mail document can be assured by satisfying these three requirements.

A second embodiment of this invention is a simpler form of the authenticity assurance apparatus for e-mail documents 10. The authenticity assurance apparatus for e-mail documents 10 of the second embodiment has the same configuration as that of FIG. 1. That is, it is exactly the same in configuration as the first embodiment. Thus, the same device can be used to provide the first embodiment or the second embodiment of this invention according to the needs of the user.

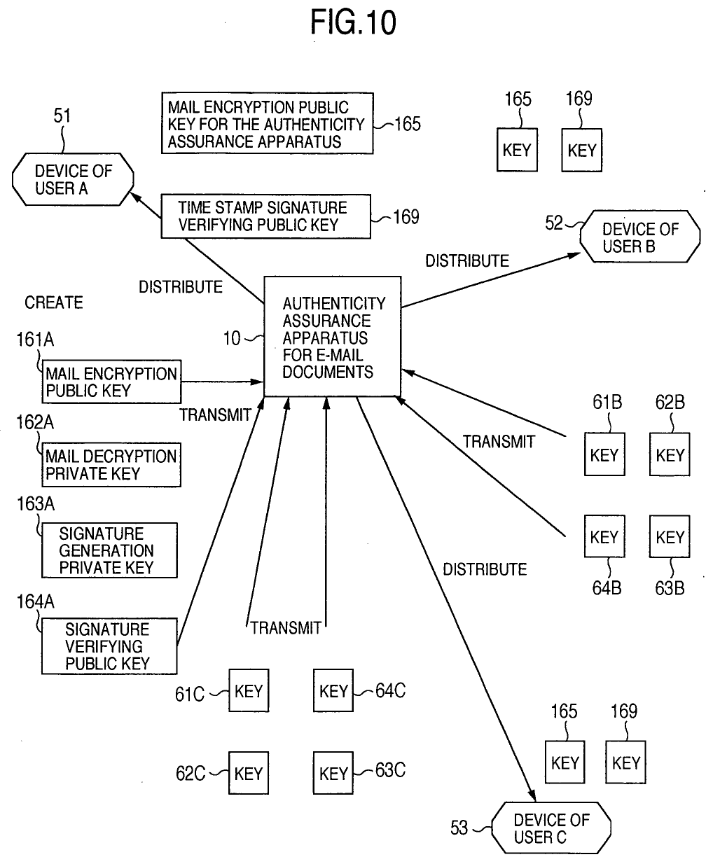

FIG. 10 illustrates a procedure for registering an applicant in the second embodiment. The basic procedure is similar to that of the first embodiment, except that an object transferred between the authenticity assurance apparatus for e-mail documents 10 and the user differs from that of the first embodiment. In the second embodiment, the distribution program 99 is not downloaded. The encryption/decryption and the signature creation/verification are left to a mail software of the user. Thus, in the case of a user who uses a mail software without such functions, this embodiment cannot be used.

During the user registration, the generation of keys and their transmission to the authenticity assurance apparatus are performed manually by the user. Four keys are created: a mail encryption public key 161, a mail decryption private key 162 paired with the mail encryption public key 161, a signature generation private key 163 and a signature verifying public key 164 paired with the signature generation private key 163. After these keys are created, the user sends the mail encryption public key 161 and the signature verifying public key 164 to the authenticity assurance apparatus for e-mail documents 10.

As keys that are first used by a sender to send a mail to the authenticity assurance apparatus for e-mail documents 10, the authenticity assurance apparatus creates a mail encryption public key 165 for encrypting mails destined for the authenticity assurance apparatus and a mail decryption private key 166 to be paired with it. The authenticity assurance apparatus distributes the public key 165 instead of the public key 161. At the same time, a time stamp signature verifying public key 169 is also distributed.

During transmission, a sender designates the authenticity assurance apparatus as the destination and either comments out a recipient name in the title name field by attaching a <destination> tag to it or enters the destination in a pre-distributed format and attaches it to the mail. Then, the sender performs encryption using the mail encryption public key 165 for the authenticity assurance apparatus and also generates and attaches a signature using the signature generation private key 163 before transmitting the mail to the authenticity assurance apparatus.

After the mail has arrived at the authenticity assurance apparatus, the mail is stored as it is. In the first embodiment, different encryption keys need to be used to encrypt the mail for different destinations, so that when the mail is stored in the authenticity assurance apparatus, all the mails that are encrypted by different keys have to be stored, necessarily increasing the required capacity of the storage media. In the second embodiment, on the other hand, the authenticity assurance apparatus temporarily decrypts the mail using the mail decryption private key 166 for the authenticity assurance apparatus and then encrypts the mail using the different mail encryption public keys 161 for the associated destinations, before attaching a time stamp signature and transmitting the mails. Therefore, if the mail has many destinations, the authenticity assurance apparatus needs only to store one copy.

In this embodiment, however, since the mail stored in this system is encrypted only by the key stored in this system and does not require another key on the destination side as in the first embodiment, the confidentiality is slightly less reliable. Further, while in the first embodiment the property is also encrypted and stored, the second embodiment does not encrypt it in order to enhance the search performance. This results in a slight degradation of the confidentiality but ensures an excellent availability. As for the search functions, the second embodiment has a search based on the property, a full-text search and a conceptual search. These functions are enabled by the fact that the mail decryption private key 166 is provided on the authenticity assurance apparatus side, and therefore can be realized only in the second embodiment. The method of creating a time stamp signature is similar to the one used in the first embodiment, except that a hash of the property not subjected to conversion is used instead of the hash of the re-converted property.

In the second embodiment, since the distribution program 99 is not distributed, if a mail is tampered with while on a route from the authenticity assurance apparatus for e-mail documents 10 to a recipient, a function of notifying the sender and recipient of the tampering when detected is not automatically executed. To realize this function requires the recipient to forward the received mail as is to the authenticity assurance apparatus for e-mail documents 10. The authenticity assurance apparatus for e-mail documents 10 that has received the forwarded mail then verifies the time stamp signature using the time stamp signature verifying public key 169, checks for any manipulation, and notifies the result to the sender and recipient.

In the second embodiment the viewing on the Web is made easier. Since the stored mail can be decrypted only by the mail decryption private key 166 held by the authenticity assurance apparatus for e-mail documents 10, the content of a mail attached file can be displayed from the Web without uploading the key as is required by the first embodiment. Thus the second embodiment is superior to the first embodiment in terms of availability.

Comparison between the first embodiment and the second embodiment shows that the first embodiment reduces the burden on the part of the user as during the mail transmission and has a high level of confidentiality. The second embodiment on the other hand has an excellent availability and can save resources. When actually serving customers, the second embodiment can provide services with less cost. These two embodiments can be chosen freely by the user according to his or her needs.

Prospective users that may introduce the authenticity assurance apparatus for e-mail documents include public third-party organizations such as courts, notary offices and Postal Service. In the case of courts and notary offices, when documents related to law suits, contracts (insurances) and negotiations are exchanged by e-mail, the contents of the e-mails bear importance during the course of trial and therefore the assurance of authenticity of the mails by using the authenticity assurance apparatus has a profound significance. In the case of Postal Service, the use of this authenticity assurance apparatus can realize a registered mail service (with mail content certified).

With the authenticity assurance apparatus for e-mail documents of this invention, three requirements—integrity, confidentiality and availability—can be assured and thus the “authenticity” of an e-mail document stored can also be guaranteed.

While the above description has been given for example embodiments, it is apparent to those skilled in the art that this invention is not limited to these embodiments and that various modifications and changes can be made in conformity with the spirit of this invention and within a scope of the appended claims.

1. An authenticity assurance apparatus for e-mail documents for preserving a transmitted e-mail document and a file attached thereto, comprising:
means for detecting a tampering with the e-mail document and the attached file;
means for notifying a sender and a recipient of the tampering when detected;
means for encrypting the e-mail document and the attached file and preserving the encrypted ones in a storage;
means for creating a time stamp signature and attaching the created signature to the e-mail; and
means for restricting an access to the storage in which the e-mail document and the attached file are preserved.

2. An authenticity assurance apparatus for e-mail documents according to claim 1, wherein the tampering detecting means receives digital data containing a body of the e-mail received from a mail sending device and a hash value of the digital data, matches a hashed value of the digital data with the received hash value, and, if not matched, decides that the e-mail has been tampered with.

3. An authenticity assurance apparatus for e-mail documents according to claim 1, wherein the encrypting and preserving means doubly encrypts encrypted data received from the mail sending device by using an encryption key stored in the authenticity assurance apparatus for e-mail documents and then records the doubly encrypted data in the database.

4. An authenticity assurance apparatus for e-mail documents according to claim 1, wherein the time stamp signature is digital data created by encrypting with a private key a combination of hash values of an encrypted mail body received from the mail sending device, a re-converted property made up of data of a destination and a title name, a time recording file for transmission that records a time at which the digital data received from the mail sending device was recorded, and a previously created time stamp signature.

5. A mail transmission program for causing a computer that transmits a mail to execute:
a function of duplicating digital data of the mail to be transmitted;
a function of changing destination addresses to which the digital data of the duplicated mails is to be transmitted to an authenticity assurance apparatus for e-mail documents;
a function of encrypting a mail body and an attached file in the digital data; and
a function of transmitting a title name, a destination, the encrypted mail body and attached file, and a mail sender certifying signature to the authenticity assurance apparatus for e-mail documents.

6. A received mail processing program for causing a computer that has received a mail to execute:
a function of verifying a received sender certifying signature by using a signature verifying key;
a function of verifying a received time stamp signature;
a function of, when the verification result is abnormal, outputting to an output device an alert message to inform a recipient of an anomaly; and
a function of, when the verification result is abnormal, returning a warning mail to an authenticity assurance apparatus for e-mail documents as a mail transmission source.

7. A mail transmission/reception acknowledging program for causing computers to execute:
a function of, when informed by a computer that has received a mail that a result of verifying a sender certifying signature or a time stamp signature is abnormal, transmitting a warning mail to a computer that has transmitted the mail and other computers that have received the mail;
a function of, when the sender certifying signature and the time stamp signature are received as a reception acknowledge mail from the computers that received the mail, matching them with information on the sender certifying signature and the time stamp signature already recorded in a storage;
a function of, when the result of verification is abnormal, sending a warning mail to the mail transmitting computer and the mail receiving computers; and
a function of, when it is found that there is no anomaly with all the mail receiving computers, sending to the mail transmitting computer an acknowledge mail containing a message indicating a transmission/reception is successfully completed and a mail ID.

8. A mail transmission program for causing a computer to transmit a mail, according to claim 5,
wherein when a tag is added to the title name of the mail, the program causes the computer to execute
a function of changing destination addresses to which the digital data of the reproduced mails is to be transmitted to the authenticity assurance apparatus for e-mail documents and
a function of adding a recipient's address to the title name of each of the duplicated mails

9. A time stamp signature verifying method for verifying the time stamp signature of claim 6 by performing the steps of:
inputting encrypted data of the time stamp signature defined in claim 4; and
comparing a hash value of data of the encrypted mail body of the received e-mail, the re-converted property and the time recording file for transmission with a corresponding hash value obtained by decrypting the encrypted time stamp signature.

10. An authenticity assurance apparatus for e-mail documents comprising:
an input unit which accepts account information of a user when a request is made for retransmitting a stored e-mail defined in claim 1;
an output unit which when the e-mail is accessible, search and output information on an encrypted property based on information on correspondence between a mail ID and a user ID; and
a retransmission unit which retransmits the mail selected by the user to a device on the user side according to an output result.
